(19) United States
(12) Patent Application Publication
(10) Pub. No.: US 2005/0097081 A1
(43) Pub. Date: May 5, 2005

(54) Apparatus and methods for compiling digital communications

(75) Inventors: Abigail Jane Sellen, Newbury (GB); Paul John Marsh, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/697,274

(22) Filed: Oct. 31, 2003

(51) Int. Cl. G06F 7/00

(52) U.S. Cl. 707/3

(57) ABSTRACT

Apparatus for processing digital communications, comprising: input means arranged to receive input specifying an interrogation criterion; interrogation means arranged to interrogate a database of digital communications sent and/or received by a user, to produce a subset of digital communications in accordance with the interrogation criterion; and compilation means arranged to produce a compilation of the subset of digital communications, the compilation having the form of a human-readable document. Preferably the compilation has the visual appearance of a scrapbook. The digital communications may be inter alia e-mail messages, images and attachments; mobile text and picture messages; and instant messages.

This invention relates to apparatus and methods for producing compilations, records or archives of digital communications. It is particularly suitable, but by no means limited, for use with e-mail communications, mobile telephone text (and picture) messaging, and instant messaging.

### BACKGROUND TO THE INVENTION

Many people use forms of digital communication such as e-mail, mobile phone text (and picture) messaging and instant messaging to communicate with friends, family members, colleagues and acquaintances. Such forms of communication have benefits over the spoken word (e.g. face-to-face or on the telephone) since the messages may be retained, for future reference or to send a reply.

It is not unusual for people to build up long histories of exchanges of such forms of communication, particularly with friends and family members. As well as including conversational text, these exchanges may also include the exchange of photographs, scanned images, and audio, video or multimedia clips. Other data files may also be exchanged.

### SUMMARY OF THE INVENTION

According to a first aspect of the invention there is provided apparatus for processing digital messages, comprising: input means arranged to receive input specifying an interrogation criterion; interrogation means arranged to interrogate a database of digital messages sent to a user, to produce a subset of messages in accordance with the interrogation criterion; and compilation means arranged to produce a compilation of the subset of messages having the form of a human-readable document.

According to a second aspect of the invention there is provided a computer program product executable to perform a method for producing a compilation of messages sent to a user, the method comprising: receiving input specifying an interrogation criterion; interrogating a database of messages sent to the user, to produce a subset of messages in accordance with the interrogation criterion; and generating a compilation of messages satisfying the interrogation criterion and having the form of a human-readable document.

According to a third aspect of the invention there is provided a computer program stored on a data carrier, the computer program being executable to perform a method for producing a compilation of a plurality of messages sent to a user, the method comprising: receiving input specifying an interrogation criterion; interrogating a database of messages sent to the a user, to produce a subset of messages in accordance with the interrogation criterion; and generating a compilation of messages satisfying the interrogation criterion and having the form of a human-readable document.

According to a fourth aspect of the invention there is provided a server configured to execute a method for producing a compilation of a plurality of messages sent to a user, the method comprising: receiving input specifying an interrogation criterion; interrogating a database of messages sent to a user, to produce a subset of messages in accordance with the interrogation criterion; and generating a compilation of messages satisfying the interrogation criterion and having the form of a human-readable document.

According to a fifth aspect of the invention there is provided a method for producing a scrapbook compilation of comprising the steps of: specifying a criterion for querying a database of messages; querying the database on the basis of the criterion to produce a result-set of messages; and generating from the result-set a compilation of messages having the form of a scrapbook document.

### BRIEF DESCRIPTION OF THE DRAWINGS

Embodiments of the invention will now be described, by way of example, and with reference to the drawings in which:

FIG. 1 illustrates a computer display showing a compilation having the visual appearance of a scrapbook;

FIG. 2 illustrates the architecture of a network arranged to enable a scrapbook compilation to be produced from e-mail messages and associated images and other attachments;

FIG. 3 illustrates the architecture of a network arranged to enable a scrapbook compilation to be produced from mobile phone text messages and mobile picture messaging;

FIG. 4 illustrates the architecture of a network arranged to enable a scrapbook compilation to be produced from instant messaging;

FIGS. 5 to 9 show examples of e-mail messages for inclusion in a scrapbook compilation; and

FIGS. 10 and 11 illustrate an example of a scrapbook compilation produced using the e-mail messages of FIGS. 5 to 9.

### DETAILED DESCRIPTION OF PREFERRED EMBODIMENTS

The present embodiments represent the best ways known to the applicant of putting the invention into practice. However they are not the only ways in which this can be achieved.

Introduction to the Scrapbook Form of Compilation

In the preferred embodiments of the invention, a computer program running on a processor is used to produce a compilation of digital communications having the visual form of a scrapbook. Mechanisms by which this may be achieved will be discussed in detail below.

The term “digital communications” should be interpreted broadly, to encompass any individual messages, photographs or images; audio, video or multimedia clips; attached files or any other data items; that are sent digitally either to or from the user.

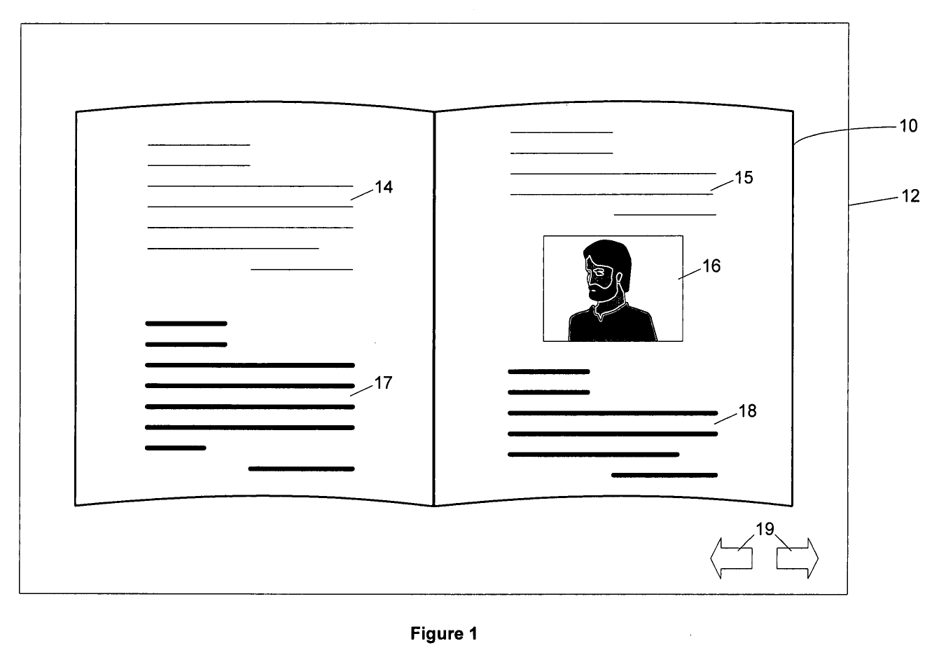

By way of an introduction to the embodiments, FIG. 1 shows an example of how a scrapbook compilation 10, produced using e-mail messages and attachments, may be displayed on the visual display 12 of a user's computer, or saved in a data file or printed out. The scrapbook method of compilation advantageously enables a sequence of snippets of conversational text to be produced, in which the text is interspersed with photographs, images, and links to other media as appropriate. In this example, the text of e-mail messages sent to the user is displayed in one colour (e.g red—depicted as light lines 14, 15), whilst the text of messages sent by the user is displayed in a different colour (e.g. blue—depicted as heavy lines 17, 18). Photographs 16 or other objects, sent to or from the user, may be included in the scrapbook, amongst the text. Audio, video and multimedia clips may also be included, as may data files, web links and other embedded objects. The content in the compilation may be arranged in chronological order (by default). Computer graphics are preferably used to make the scrapbook compilation resemble the pages of a traditional scrapbook, laid open, as FIG. 1 shows.

The scrapbook compilation may be displayed two pages at a time, as shown in FIG. 1, or in other formats. If the compilation uses more pages than fit on the screen at any one time, then control icons such as the forward and back arrows 19 may be provided to enable the user to select which pages are to be viewed. Appropriate user interfaces will be well known and understood by those skilled in the art, and need not be described further here.

Further ways in which the user may interact with the scrapbook will be discussed later.

When compared with traditional electronic messaging programs, producing a scrapbook compilation provides a more flexible way of storing and viewing e-mail and other digital communications, by transforming the digital communications into a record of a relationship or a conversation, rather than keeping them as a collection of separate messages. This overcomes or at least mitigates some of the problems people have experienced when trying to follow the thread of past electronic conversations (e.g. as conducted by e-mail, text messaging or instant messaging). It also enables the user to find things that have been said, in a straightforward and intuitive manner. Furthermore, with such a compilation, people may reminisce more easily over the course of a relationship, as the compilation enables them to see at a glance how their interactions with others have developed over time. Additionally, the compilation provides an intuitive place in which to store digital photographs or other images received using digital forms of communication.

Scrapbooks Using E-Mail Messages and Attachments

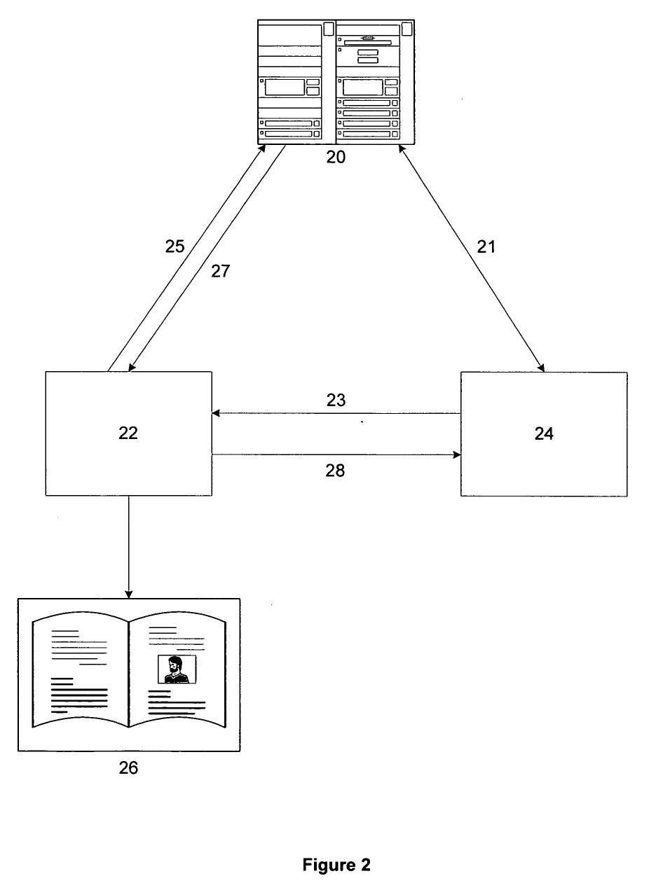

FIG. 2 shows a schematic network architecture arranged to enable a scrapbook compilation to be produced using e-mail messages and attachments. Here, a conventional messaging server 20 database is used to store the messages and attachments, which may include photographs, images, audio, video, multimedia clips, attached files and other data items.

The user interacts with the messaging server 20 via a mail client 24, such as Microsoft (RTM) Outlook (RTM), using a personal computer, a personal digital assistant (PDA) or another data processing device. Communication between the messaging server 20 and the mail client 24 takes place using a conventional e-mail protocol 21, such as IMAP or MAPI.

To enable the user to generate scrapbook compilations, a scrapbook program 22 is run on a processor. The scrapbook program 22 may be installed and run on the user's personal computer, or may be run as an applet by a webserver. In the present embodiment, the scrapbook program 22 has its own connection with the mail server 20, again using IMAP, MAPI or another suitable e-mail protocol. The scrapbook program 22 is also in communication with the mail client 24, although it may alternatively be incorporated in the mail client 24, either as an integral part of the mail client program 24 or as a plug-in.

To generate a scrapbook compilation, the user supplies an interrogation criterion on which the scrapbook compilation is to be based. In this and other embodiments, the term “interrogation criterion” should be interpreted broadly, to encompass the explicit selection of one or more digital communications by the user, and also search requests that cause the database to be searched for appropriate digital communications.

A search request may be entered directly into the scrapbook program 22, using input means provided by the user's computer (e.g. keyboard and mouse) and an appropriate user interface in the software. However, in the presently preferred embodiment the search request may be made within the mail client 24. For example, the user may wish to produce a compilation of e-mail messages and attachments relating to a friend, Tom, and accordingly specifies “Tom” as the search request. The search request may be entered into a search box (in the mail client 24 or the scrapbook program 22) configured to receive textual user input. Alternatively, the user may submit the search request another way, such as by right-clicking the mouse pointer on Tom's name within an e-mail message.

The mail client 24 then transmits 23 the interrogation criterion to the scrapbook program 22. Interrogation means provided by the scrapbook program 22 then interrogate 25 the mail server, and download 27 a subset of e-mail messages and attachments that correspond to the interrogation criterion (e.g. the search request for the friend Tom). In this and other embodiments, the term “subset” should be interpreted broadly, to encompass a single digital communication for inclusion in the compilation, or a plurality of digital communications.

Search requests and mail server interrogation may be carried out in different ways. In a simple form of search, the mail server 20 is interrogated for all messages containing a search string (e.g. “Tom”). In such cases, the sender's name, recipient's name, subject line, the rest of the header, and the text of the e-mail message itself may be searched for the search string. By default, all of the user's mail folders/directories are searched, although the search may be limited to specific folders if required.

However, more sophisticated methods are possible by which the mail server 20 is interrogated—e.g. by employing artificial intelligence algorithms. Such algorithms may be used to identify messages other than those which simply contain a search term, but which are relevant nonetheless. For example, artificial intelligence algorithms may operate by identifying relationships between people (or places, events etc.) and then using these relationships to find relevant messages. For example, if one message refers to “David's brother Tom”, the artificial intelligence algorithms can use this information to extend the search to include any messages which refer to “David's brother”, or “your brother” if the message was sent to David, or “my brother” if the message was sent by David. Accordingly, these messages are downloaded to the scrapbook program 22 too, for inclusion in the compilation about Tom.

Artificial intelligence algorithms may also be used to identify images (and other e-mail attachments) relating to the search term. For example, if an e-mail message includes a photograph of the person Tom, artificial intelligence algorithms may be employed to perform an analysis of the features of the photograph (e.g. the characteristics and proportions of a face, etc.) and then find other photographs on the mail server 20 having the same characteristic features. Thus, photographs of Tom could be found, even if his name is not directly associated with them. The relationship algorithm described above can also be used to identify images, recognising for example that a photograph of “David's brother” is actually a photograph of Tom, and should therefore be included.

The artificial intelligence algorithms are able to identify the subject matter of the compilation, which may be a topic rather than a person, and interrogate the mail server accordingly. This provides the advantage that the compilation may be based on subject matter specified by the user, rather than, for example, simpler user-defined criteria such as the name of the other party with whom the correspondence has taken place. Thus, a series of messages on a particular subject may be identified and compiled, even without specific textual matter being present in each message.

The results obtained by the artificial intelligence algorithms in such a search may be verified by the user if necessary. The user may explicitly select messages, images or other data items for inclusion in the scrapbook compilation. Likewise, the user may delete any messages, images or other items from the compilation, as desired.

On downloading the e-mail messages and images (and other items if applicable) from the mail server 20, compilation means provided by the scrapbook program 22 compile a scrapbook compilation 26 of the downloaded content. Another artificial intelligence algorithm may be employed to remove duplicate content from the e-mail messages and images (or audio, video or multimedia clips) prior to their inclusion in the scrapbook compilation. Conventionally, in an exchange of conversational e-mail messages, previous messages in the exchange may well be repeated beneath each person's reply. In the production of the scrapbook compilation, however, such repeated matter is removed so that only each person's contribution to an e-mail exchange (i.e. the part of each message that was added before each message was sent) is included in the compilation. Duplicated images and other attached items are also removed. This provides the advantage that the length of the compilation is not made unduly long by the inclusion of any unnecessarily repeated text.

Not all the non-duplicated text in an e-mail message need be transferred into the scrapbook compilation. A ‘detail’ parameter may be provided in the scrapbook program 22 or mail client 24. The ‘detail’ parameter enables the user to specify the level of detail of the e-mail content to be transferred into the scrapbook compilation. One setting of this parameter, which may be called ‘detailed’ or ‘high’, would be used to transfer all the message content that satisfies the interrogation criterion. (The messages, or the parts of the messages, which best satisfy the interrogation criterion may be highlighted.) Another setting, which may be called ‘summary’ or ‘low’, just causes the first few lines of each e-mail message to be included in the compilation. An ‘intermediate’ degree of detail may also be provided for selection, which would come between ‘detailed’ and ‘summary’.

In producing the scrapbook compilation, the header information from each e-mail message may be modified and repositioned with respect to the message text. In one embodiment only the sender's name, date and the subject of each message is included, either before or after the corresponding text of the message.

In generating the scrapbook compilation 26 (also as shown in FIG. 1), the scrapbook program 22 is configured to set out the text and images in an attractive manner. An algorithm may be provided to determine the layout of the pages. The page layout algorithm uses pre-defined rules to determine the optimum layout of the text and images, and this layout is produced by default. However, the user may subsequently alter the position of the text and images manually, e.g. by dragging and dropping the text and images around the display using a mouse.

Audio, video or multimedia objects, or other data items such as files, may be included in the scrapbook compilation along with text and images. These objects (some of which may be regarded as ‘dynamic’) are represented by an icon, link or other such representation within the scrapbook. When the scrapbook is displayed on a computer, the objects may be opened or activated by the user clicking on the corresponding icon or link. Web links may also be included, the corresponding web page being activated when the user clicks on the link with his mouse.

The order in which the messages and other objects are included in the scrapbook compilation may be specified by a user-selected sequencing criterion. By way of example, the content may be sequenced chronologically, in terms of size, or may be grouped by sender or by topic. Other sequencing criteria are possible. When the content is grouped by topic, the content is ordered chronologically within each topic, to preserve the conversational thread.

Once produced, the compilation can be saved as a data file. The messages, images and other data items within the compilation are incorporated in the data file, so that the compilation is self-contained. The compilation may be saved on the user's personal computer, or transferred 28 back to the user's mail client 24, or saved elsewhere, such as on a webserver.

The compilation may be saved as a completed article, finished as at that point in time. Alternatively the user may add or remove further messages, images or other items as and when desired, and the updated compilation may be saved under user control. Further messages may be added from within the mail client 24, e.g. by presenting the user with the option of adding an incoming message to the scrapbook compilation. If the compilation is saved within the mail client 24 as mentioned above, then the compilation may take the form of a scrapbook folder within the mail client and the user may drag e-mail messages and other items directly into the scrapbook folder for immediate inclusion in the compilation.

A further option is that the compilation may be self-updating, when new messages are received or sent. Here, the mail server 20 is continually monitored for new messages that satisfy search criteria, and messages that do are automatically added to the compilation by the scrapbook program 22.

If desired, the scrapbook program 22 may be used to produce a compilation entirely made up of specific messages chosen by the user, without using any automated search or interrogation procedure.

Once produced, the user may apply a filter to specify how much of the content of the compilation is viewed. This filter is similar to the ‘detail’ parameter described above, in that it enables the messages to be viewed in different levels of detail. However, in contrast to the ‘detail’ parameter which specified the amount of detail that was downloaded into the compilation, this filter merely alters how much of the compilation content is viewed. Use of this filter does not delete content from the compilation, enabling the user to revert to a more complete view of the content on a later occasion, as desired.

Although the scrapbook compilation may be kept as a digital entity, it may also be printed if required—for example to enable it to be kept as a memento or keepsake, or presented to someone as a gift. The printed compilation may subsequently be reviewed or studied, and may be given to someone who does not have access to a computer.

The visual layout of the compilation may be reformatted if necessary to optimise it for printing. Further printing options may be provided, such as generating a cover page. One design of cover page may be used when the scrapbook is being printed as a gift, whereas an alternative design may be used if the compilation is to be printed for professional reasons (e.g. to hand to a colleague at work).

The production of scrapbook compilations may be provided as a service, particularly if provided over the internet by a webserver. Users may be charged a subscription, or one-off fees, to use the service.

Other styles of presentation of compilations are possible, other than as a scrapbook, and the user may select a style from a number of options provided. For example, the messages and images may be displayed in a formal style, which may be more suitable when the compilation is being generated for professional purposes.

Worked Example

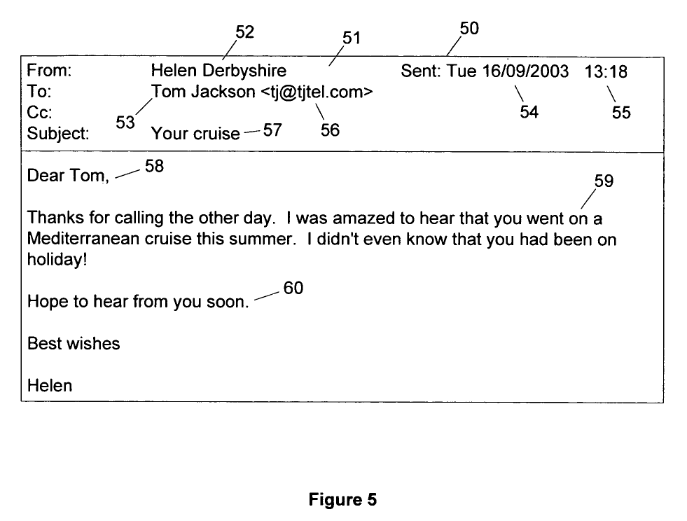

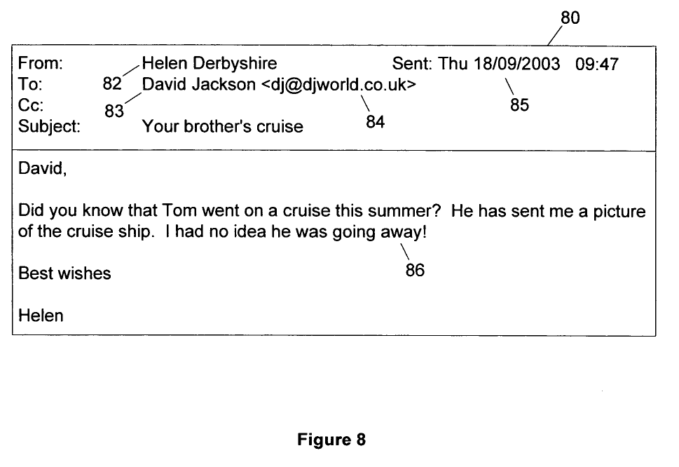

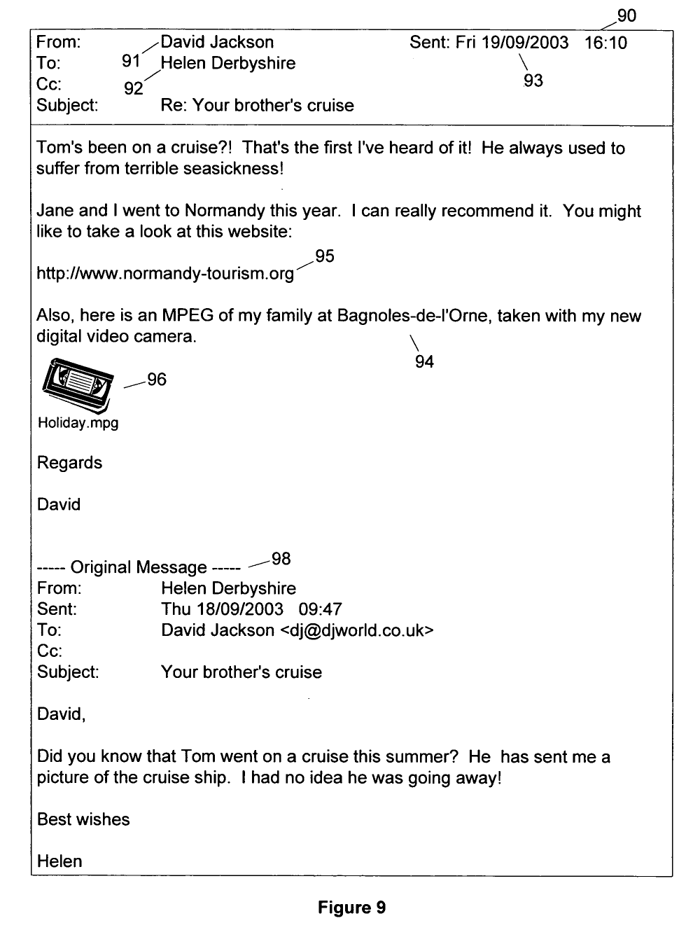

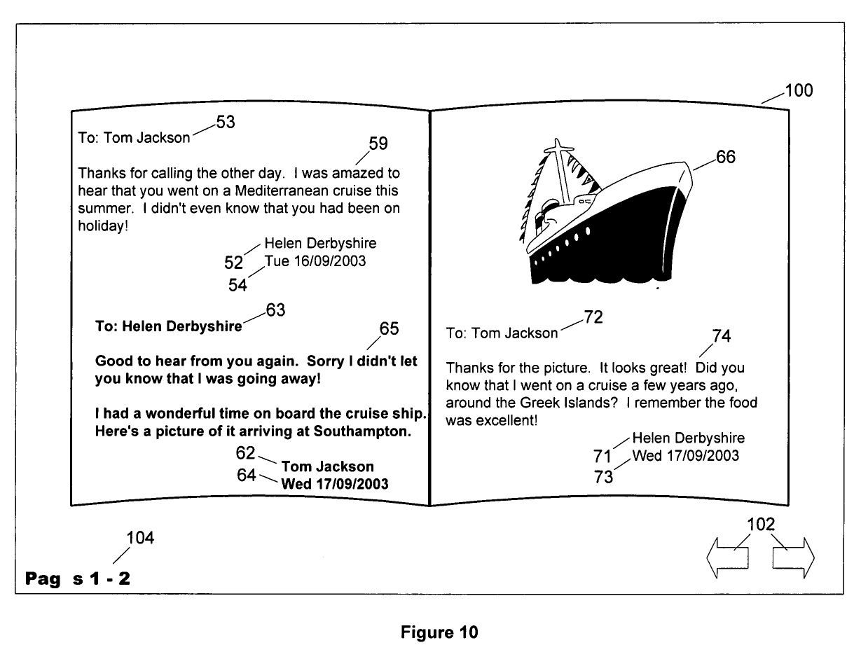

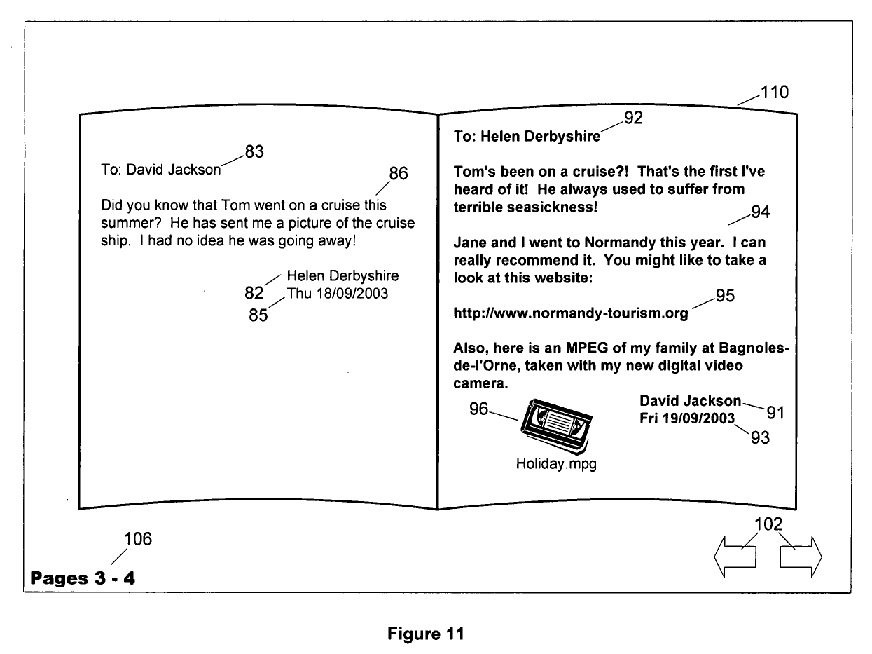

A worked example showing the generation of a scrapbook compilation from e-mail messages is shown in FIGS. 5 to 11. The scenario is that Helen Derbyshire has an e-mail dialogue with a friend, Tom Jackson, concerning his recent holiday (FIGS. 5 to 7). She also has a related e-mail discussion with Tom's brother, David Jackson (FIGS. 8 and 9). After sending and receiving e-mail messages to and from these people, Helen decides to use the system described above to produce a scrapbook compilation of these messages and associated attachments (FIGS. 10 and 11).

FIG. 5 shows the first e-mail message 50 that Helen sends to Tom. In the header 51 of this message are Helen's name 52 (in the “From” field), Tom's name 53 and his e-mail address 56 (in the “To” field), the date 54 and time 55 when the message was sent, and the subject of the message 57. The body of the message contains text elements 58, 59 and 60. In this example, text elements 58 and 60 are essentially pleasantries included out of courtesy, and text element 59 provides the substantive content of the message. Also included is an attachment, here a data file in which a picture is recorded in .jpg (Joint Photographic Experts Group) format.

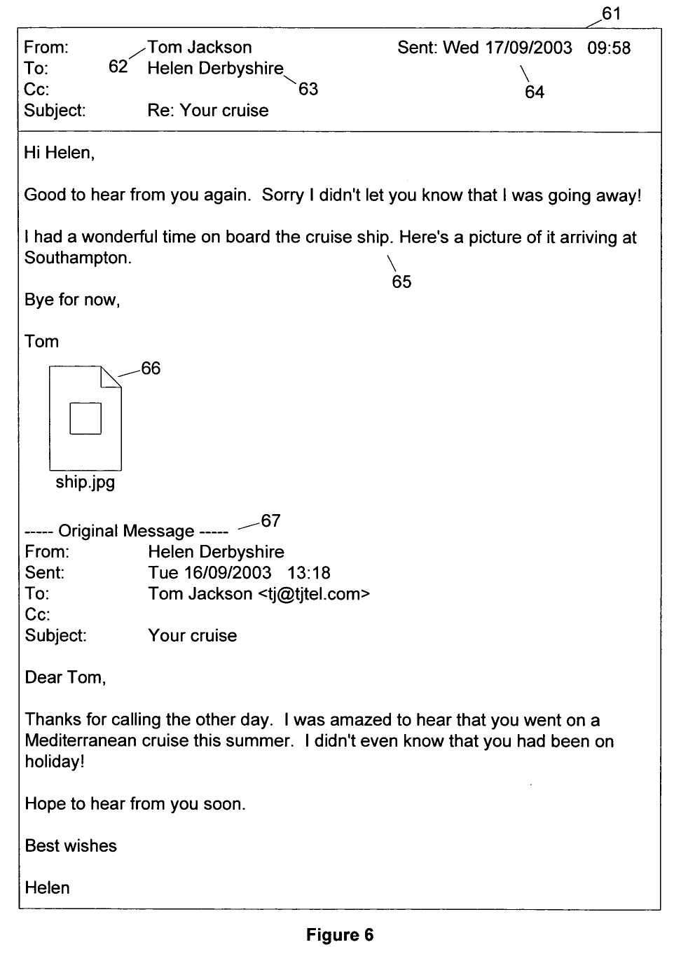

FIG. 6 shows Tom's e-mail message 61 in reply. Here, the original message 67 sent by Helen is duplicated at the foot of his message. In the header of the message 61 are inter alia Tom's name 62 as the sender, Helen's name 63 as the recipient, and the date of sending 64. The text of the message 65 includes two paragraphs of substantive text. An image file 66 is also included as an attachment.

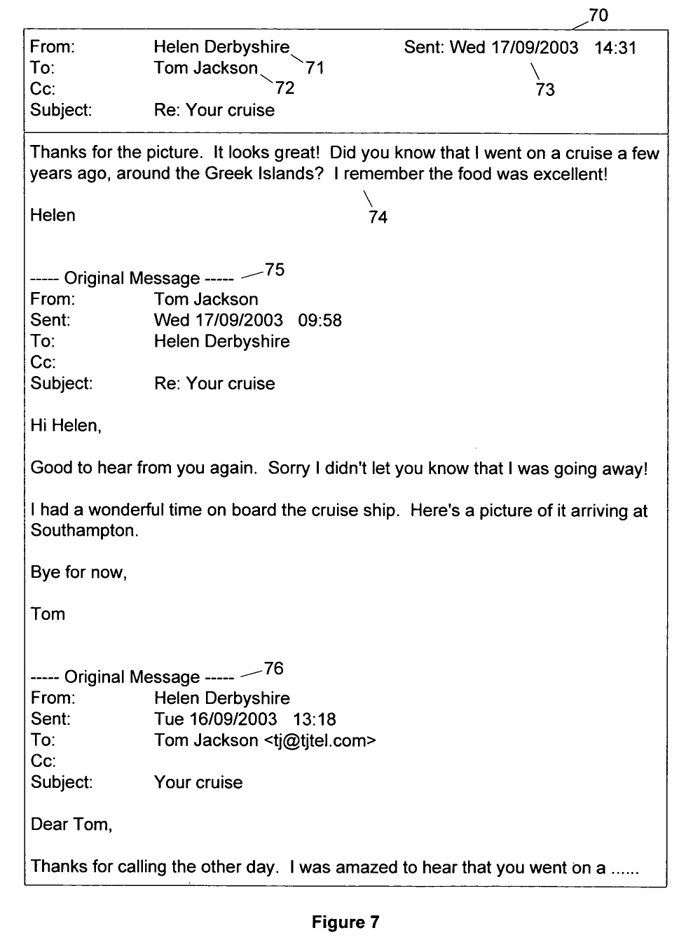

FIG. 7 shows a further message 70 sent by Helen 71 to Tom 72. The message includes a paragraph of substantive text 74. The original message 75 sent by Tom is duplicated below, which also includes Helen's initial message 76. The header includes the date 73 when the message was sent.

FIG. 8 shows a separate message 80 sent by Helen to Tom's brother David. As with the other messages, the header includes the sender's name 82, the recipient's name 83 (and e-mail address 84) and the date 85 when the message was sent. The body of the message includes a paragraph 86 of substantive text.

Finally, FIG. 9 shows a message 90 sent by David in reply. The header includes the sender's name 91, the recipient's name 92, and the date 93. Within the text of the message 94, David has included a hypertext link 95 to a website, and an attached MPEG video file 96.

In this example, Helen would like a scrapbook compilation to be produced of her recent correspondence with or about Tom Jackson. Helen's personal computer is running a scrapbook program 22 in communication within her e-mail client 24. Within the scrapbook program 22 she enters “Tom Jackson” as the interrogation criterion. The scrapbook program then interrogates her mail server 20 for messages which satisfy the interrogation criterion.

The scrapbook program 22 identifies messages 50, 61 and 70 for inclusion in the compilation, since these messages all contain the string “Tom Jackson”. By employing artificial intelligence, the program also identifies messages 80 and 90 as being of relevance. This is achieved by the artificial intelligence algorithm identifying that message 80 is addressed to David Jackson, the subject line makes reference to “your brother”, and the message mentions “Tom”. It is therefore able to recognise that the subject of the message is Tom Jackson. Message 90 is sent in reply to message 80, and is therefore also identified as being for inclusion in the compilation.

The scrapbook program 22 then downloads messages 50, 61, 70, 80 and 90 from the mail server 20. The program then removes duplicated content from the messages, such as the copied text 67, 75, 76 and 98 included under the heading “Original Message” within some of the messages.

In this example, the user Helen has specified that a medium level of message detail be transferred from the e-mail messages into the scrapbook compilation. This level of detail has the effect of including only the substantive content of each message, and not the opening and closing pleasantries (e.g. text elements 58 and 60 of FIG. 5) that may be present in the messages.

The scrapbook program 22 then generates the scrapbook compilation 100, 110 as shown in FIGS. 10 and 11. As discussed above, the compilation is arranged to have the visual appearance of a scrapbook. In this case, the scrapbook has four pages of content, the page numbers being indicated (104, 106). When viewed on a computer, the arrow icons 102 are selectable to enable the user to view the different pages as desired.

The scrapbook compilation 100, 110 includes the substantive textual content 59, 65, 74, 86 and 94 extracted from messages 50, 61, 70, 80 and 90. Before each message the recipient's name (53, 63, 72, 83, 92) is presented, and after each message the corresponding sender's name (52, 62, 71, 82, 91) and date (54, 64, 73, 85, 93) are set out.

In this example, in the interest of presentation, the times when the messages were sent, the e-mail addresses and the subject lines are not included in the scrapbook compilation.

In addition, the program includes an opened version of the picture 66 that was included as an attachment to message 61 in the scrapbook, following the text 65 to which it relates.

With message 90, the hypertext link 95 is included in the compilation within the substantive text 94. When the compilation is viewed on a computer, the link may be clicked on to open the corresponding web page. The MPEG file 96 that was attached to message 90 is also presented as an icon, which may also be clicked on to play the video (e.g. in a separate window).

Scrapbooks Using Mobile Text Messaging and Picture Messaging

With mobile phone text (e.g. SMS) or picture messaging (and likewise with instant messaging) facilities for archiving and managing messages sent or received by a user have traditionally been basic. For many users, text messages are simply stored in a single mailbox, and instant messages are commonly not stored at all.

However, instead of using e-mail messages and attachments as discussed above, a scrapbook compilation may be produced using text, picture, video or multimedia messaging, performed using mobile phones or other mobile stations. The form of the scrapbook compilation that is produced is substantially as previously described.

The term “mobile station” should be interpreted broadly, to include mobile telephones, personal digital assistants (PDAs), pagers, and other portable or mobile electronic communications devices.

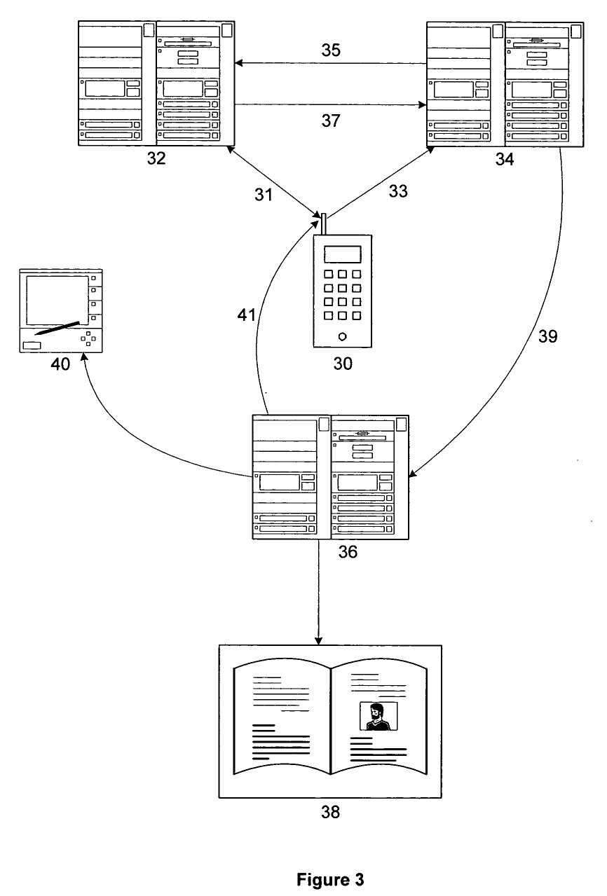

FIG. 3 shows a schematic network architecture arranged to enable a scrapbook compilation to be produced using mobile phone text messaging and picture messaging. Here, the user operates a mobile station 30, which is shown in the figure as being a mobile phone, but which may be another form of mobile device such as a PDA. The mobile station 30 is in communication 31 with a messaging server 32, which is typically hosted by the telecommunications provider. The messaging server 32 stores the text and picture messages sent to and from the user.

The scrapbook compilation is generated by a compilation server 34, which is also in communication with the mobile station 30. To initiate the creation of a scrapbook compilation, the user inputs a compilation generation request via input means provided by the mobile station 30, which is configured and programmed to receive and process such requests. This request may be made by the user typing in a search term on the mobile station's keypad, or by selecting an existing message having subject matter around which the search is to be based. Specific messages and pictures etc. may also be explicitly selected for inclusion in the compilation.

The compilation generation request may alternatively be made via the internet.

The mobile station 30 then transmits a compilation generation request 33 to the compilation server 34, specifying an interrogation criterion. Upon receiving the request, interrogation means provided by the compilation server 34 interrogate 35 the messaging server 32 for messages, images and other data items in accordance with the interrogation criterion. The interrogation process is as described previously with respect to e-mail messages. Artificial intelligence algorithms may be used to find messages and images which relate to the interrogation criterion, but which do not themselves contain a search term. Other algorithms may be used to find images using feature analysis. Duplicated content may be automatically removed, as previously described, and a ‘detail’ parameter may be specified to determine the level of detail of the messages to be incorporated into the compilation.

The relevant messages, images and other data items are then downloaded 37 from the messaging server 32 to the compilation server 34. Compilation means provided by the compilation server 34 then compile the scrapbook compilation, formatting it as previously described. Individual users' messages may be represented in different colours, and the layout of the pages are optimised according to pre-defined rules as mentioned previously. Images are included, together with icons or links representing ‘dynamic’ content such as audio, video or multimedia clips. The compilation may be generated in HTML format (although other data file types are possible), to enable it to be viewed over the internet.

The scrapbook compilation is then transmitted 39 to a webserver 36, from which it may be accessed, viewed and printed using a web browser on a personal computer 38, or saved on a computer 38 for future reference. (The webserver 36 may be the compilation server 34.) The user may be required to submit a user identifier and password in their web browser in order to access the scrapbook compilation.

The URL address of the web server 36, and the user identifier and password if necessary, may be transmitted as a text message 41 from the webserver 36 to the mobile station 30. The receipt of this message 41 by the user provides confirmation that the scrapbook compilation has been generated and is ready to be viewed.

Instead of viewing the scrapbook compilation on the personal computer 38, the user may alternatively view it on the mobile station 30 (if it supports the viewing of HTML files and the like) or on a separate PDA 40.

Users may be charged to use this archiving service. Other styles of presentation of compilations are possible, other than as a scrapbook, and the user may select a style from options provided.

Scrapbooks Using Instant Messaging

Scrapbook compilations, as previously described, may also be produced using instant messages sent between computer users.

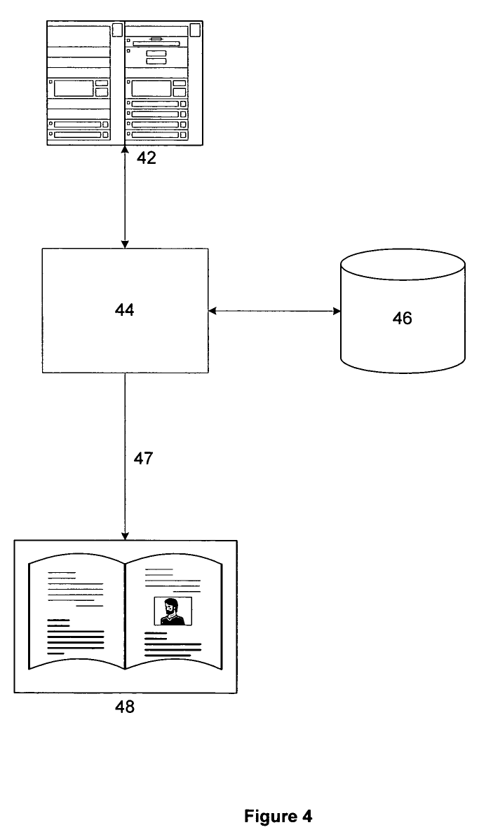

FIG. 4 shows a network architecture that enables scrapbook compilations to be produced using instant messaging. With instant messaging, the messaging server 42 merely transmits and receives message data, and does not store them. To enable compilations of instant messages to be produced, it is therefore also necessary to store the messages once they have been sent or received.

Accordingly, in this embodiment of the invention, a modified instant messaging client 44 is installed on the user's personal computer. This modified client 44 not only handles the sending and receiving of instant messages, but also stores in a database 46 the instant messages and attachments that are sent or received. The database 46 may be stored on the user's computer itself, or on a connected server. Furthermore, the modified client 44 also incorporates a scrapbook compilation program as described previously, to enable a scrapbook compilation 48 to be produced using the instant message data stored in the database 46.

The modified client software 44, and the keyboard and mouse of the user's computer, provide input means to enable the user to input a request to generate a scrapbook compilation, and to supply an interrogation criterion (e.g. a search request or the selection of one or more specific messages). The interrogation and compilation process is then executed by interrogation and compilation means provided by the modified client 44. The database 46 is interrogated as described previously, using artificial intelligence algorithms and permitting the user to modify the composition of the compilation as desired. A scrapbook compilation 48 is then generated, which may be saved, viewed or printed as desired. The compilation 48 may be automatically updated as further instant messages are sent or received.

Users may be charged to use this archiving service. Other styles of presentation of compilations are possible, other than as a scrapbook, and the user may select a style from options provided.

1. Apparatus for processing digital messages, comprising:
input means arranged to receive input specifying an interrogation criterion;
interrogation means arranged to interrogate a database of digital messages sent to a user, to produce a subset of messages in accordance with the interrogation criterion; and
compilation means arranged to produce a compilation of the subset of messages having the form of a human-readable document.

2. Apparatus as claimed in claim 1, wherein the compilation has the visual appearance of a scrapbook.

3. Apparatus as claimed in claim 1, wherein content of the messages is of a type selected from a group comprising: e-mail messages; data files attached to e-mail messages; images; multimedia clips.

4. Apparatus as claimed in claim 3, wherein the database is a messaging server.

5. Apparatus as claimed in claim 3, wherein the input means are operable to receive the interrogation criterion from the user's e-mail client application.

6. Apparatus as claimed in claim 3, wherein the interrogation means are configured to employ artificial intelligence algorithms when producing a subset of messages.

7. Apparatus as claimed in claim 6, wherein the compilation means is operable to remove duplicated content from messages for inclusion in the subset.

8. Apparatus as claimed in claim 6, wherein the compilation means is operable to identify e-mail messages in the database having content relating to common subject matter for inclusion in the subset.

9. Apparatus as claimed in claim 8, wherein the compilation means are further operable to remove header information from e-mail messages when producing the compilation.

10. Apparatus as claimed in claim 3, further operable to save the compilation in a data file.

11. Apparatus as claimed in claim 10, further operable to store the compilation within the user's e-mail client application.

12. Apparatus as claimed in claim 10, further operable to store the compilation in the database.

13. Apparatus as claimed in claim 1, wherein the messages are of a type selected from a group comprising: text messages sent to or from mobile stations; picture messages sent to or from mobile stations; multimedia clips sent to or from mobile stations; data files sent to or from mobile stations.

14. Apparatus as claimed in claim 13, wherein the database is a mobile telecommunications messaging server.

15. Apparatus as claimed in claim 13, where the input means are operable to receive the interrogation criterion from a mobile station.

16. Apparatus as claimed in claim 13, wherein the input means are operable to receive the interrogation criterion via the internet.

17. Apparatus as claimed in claim 13, wherein the interrogation means are configured to employ artificial intelligence algorithms when producing a subset of digital communications, the artificial intelligence algorithms being operable to identify messages having content relating to common subject matter for inclusion in the subset.

18. Apparatus as claimed in claim 13, incorporated in a server in communication with the mobile telecommunications messaging server.

19. Apparatus as claimed in claim 13, further operable to transmit the compilation to the user's mobile station.

20. Apparatus as claimed in claim 13, further operable to store the compilation on a webserver.

21. Apparatus as claimed in claim 20, further operable to send the user access details to enable the user to access the compilation stored on the webserver.

22. Apparatus as claimed in claim 1, wherein the digital messages are instant messages, and wherein the apparatus further comprises a database on which the instant messages are stored when sent and/or received.

23. Apparatus as claimed in claim 22, wherein the database is stored in the user's personal computer.

24. Apparatus as claimed in claim 22, wherein the database is stored on a server in communication with the user's personal computer.

25. Apparatus as claimed in claim 22, wherein the input means are operable to receive the interrogation criterion from the user's instant messaging client application.

26. Apparatus as claimed in claim 22, wherein the interrogation means are configured to employ artificial intelligence algorithms when producing a subset of digital communications, the artificial intelligence algorithms being operable to identify messages having content relating to common subject matter for inclusion in the subset.

27. Apparatus as claimed in claim 1, wherein the compilation means are operable to arrange a sequence of the digital messages in the compilation according to a sequencing criterion specified by the user selected from a group comprising: chronological order; quantity of content; identity of sender; subject matter.

28. Apparatus as claimed in claim 1, wherein the compilation means are operable to adjust a level of detail of the digital communications presented in the compilation according to a criterion specified by the user.

29. Apparatus as claimed in claim 1, further operable to print the compilation.

30. Apparatus as claimed in claim 1, wherein the compilation means is further operable to automatically update the compilation when the user sends or receives further digital communications.

31. Apparatus as claimed in claim 1, wherein the input means are further operable to receive input specifying a specific digital communication to be added to or removed from the compilation, and wherein the compilation means are operable to add or remove said specific digital communication to or from the compilation.

32. A computer program product executable to perform a method for producing a compilation of messages sent to a user, the method comprising:
receiving input specifying an interrogation criterion;
interrogating a database of messages sent to the user, to produce a subset of messages in accordance with the interrogation criterion; and
generating a compilation of messages satisfying the interrogation criterion and having the form of a human-readable document.

33. A computer program as claimed in claim 32, further comprising an integrated e-mail client.

34. A computer program as claimed in claim 32, further comprising an integrated instant messaging client.

35. A computer program stored on a data carrier, the computer program being executable to perform a method for producing a compilation of a plurality of messages sent to a user, the method comprising:
receiving input specifying an interrogation criterion;
interrogating a database of messages sent to the a user, to produce a subset of messages in accordance with the interrogation criterion; and
generating a compilation of messages satisfying the interrogation criterion and having the form of a human-readable document.

36. A server configured to execute a method for producing a compilation of a plurality of messages sent to a user, the method comprising:
receiving input specifying an interrogation criterion;
interrogating a database of messages sent to a user, to produce a subset of messages in accordance with the interrogation criterion; and
generating a compilation of messages satisfying the interrogation criterion and having the form of a human-readable document.

37. A method for producing a scrapbook compilation of comprising the steps of:
specifying a criterion for querying a database of messages;
querying the database on the basis of the criterion to produce a result-set of messages; and
generating from the result-set a compilation of messages having the form of a scrapbook document.

38. A method according to claim 37 wherein the step of generating a compilation includes the step of removing duplicated content.

39. A method according to claim 38 wherein the step of generating a compilation includes the steps of opening attachments and incorporating opened attachments in the scrapbook document.

40. A method according to claim 39 wherein the result set includes messages sent by a plurality of people.

41. A method according to claim 40 wherein the result set includes messages sent by the user.

42. A method according to claim 37 wherein querying the database is performed using an artificial intelligence algorithm.
